(19) United States
(12) Patent Application Publication
(10) Pub. No.: US 2010/0040410 A1
(43) Pub. Date: Feb. 18, 2010

(54) ACCESSORY ATTACHING SYSTEM

(75) Inventors: David Russell King, Annandale (AU); Steve Higgs, Lane Cove (AU)

Correspondence Address: Nelson Mullins Riley & Scarborough LLP;IP Department, 100 North Tryon Street, 42nd Floor, Charlotte, NC, 28202-4000, US

(73) Assignee: King Furniture (Australia) Pty Ltd, Turrella (AU)

(21) Appl. No.: 12/504,340

(22) Filed: Jul. 16, 2009

(30) Foreign Application Priority Data
Jul. 17, 2008 (AU) 2008903658

(51) Int. Cl. F16D 1/06

(52) U.S. Cl. 403/361

(57) ABSTRACT

The present disclosure provides an accessory attaching system (10) for use with an article of furniture (13). The system (10) comprises a socket defining member (12) to be received by one of an accessory (18) and an underlying component (16) to which the accessory (18) is to be attached. A retention device (20) is mountable to the other of the accessory (18) and the underlying component (16) to retain the accessory and the underlying component in position relative to each other. The retention device (20) is shaped to be a snug fit in a socket (14) defined by the socket defining member (12). A restraining formation (28) is carried on the retention device (20) for engaging a complementary element (32) carried by one of the accessory (18) and the underlying component (16) to inhibit lateral displacement of the accessory (18) relative to the underlying component (16).

### CROSS-REFERENCE TO RELATED APPLICATIONS

The present application claims priority from Australian Provisional Patent Application No. 2008903658 filed on 17 Jul. 2008, the content of which is incorporated herein by reference.

### FIELD

This invention relates, generally, to an article of furniture and, more particularly, to an accessory attaching system for use on an article of furniture and to an article of furniture comprising an accessory attaching system.

### BACKGROUND

Modem interior decorating trends increasingly make use of modular furniture. In addition to increased versatility, this also has the benefit that the modular arrangement of furniture can be accessorised to render it suitable for a particular location and/or purpose.

A need exists to ensure that an accessory is attachable to an article of furniture in a secure manner to impart stability to the completed structure.

In this specification, the term “accessory” is to be understood in a broad sense as comprising any article, such as an armrest, a headrest, a

### SUMMARY

A first aspect provides an accessory attaching system comprising:
a socket defining member to be received by one of an accessory and an underlying component to which the accessory is to be attached;
a retention device mountable to the other of the accessory and the underlying component to retain the accessory and the underlying component in position relative to each other, the retention device being shaped to be a snug fit in a socket defined by the socket defining member; and
a restraining formation carried on the retention device for engaging a complementary element carried by one of the accessory and the underlying component to inhibit lateral displacement of the accessory relative to the underlying component.

The socket defining member may be receivable in the underlying component, which may be a seat base of a sofa. The retention device may be carried by the accessory.

The socket defining member may comprise a sleeve defining the socket.

An outwardly extending flange may be arranged about an inlet opening of the socket.

The retention device may be a magnetic retention device and may comprise a magnet for retention to a ferro-magnetic component in the other of the accessory and the underlying component. The magnet may be a high strength magnet and, preferably, may be a rare earth magnet. The retention device may comprise a holder that is engageable with the socket and the magnet is preferably received in the holder.

The socket may be tapered. The retention device may be tapered and the taper of the retention device may be complementary to that of the socket so that, in use, the retention device is a snug fit within the socket and locks in position within the socket defining member while inhibiting binding between the socket defining member and the retention device. The taper of both the retention device and the socket may be less than about 5°, and, more preferably, may be less than about 2°.

The retention device may comprise a crown portion with a skirt portion depending from one side of the crown portion. The skirt portion may be arranged inwardly of a periphery of the crown portion. An opposed side of the crown portion may define a land and the restraining formation may project from the land.

The system may comprise the complementary element. In the case where the socket defining member is arranged in the underlying component, the complementary element may be carried on an operatively underside of the accessory. The complementary element may be magnetically responsive and may have a receiving formation, for example, an opening, defined in it in which the restraining formation is received to be a snug fit to locate the accessory laterally with respect to the underlying component, in use.

A second aspect provides an article of furniture comprising:
a base member forming an underlying component;
at least one accessory releasably attachable to the base member; and
at least one accessory attachment system, comprising:
a socket defining member to be received by one of the accessory and the underlying component;
a retention device mountable to the other of the accessory and the underlying component to retain the accessory and the underlying component in position relative to each other, the retention device being shaped to be a snug fit in a socket defined by the socket defining member; and
a restraining formation carried on the retention device for engaging a complementary element carried by one of the accessory and the underlying component to inhibit lateral displacement of the accessory relative to the underlying component.

The accessory may define a receiving formation in which the complementary element of the attachment system is received. The accessory may be attached to the underlying component by a plurality of the accessory attachment systems and the accessory may define a receiving formation for each complementary element.

Each receiving formation may define a recess, which may have a depth greater than a thickness of the complementary element. The receiving formations may be defined in a member carried on an underside of the accessory. For example the member may be a timber sheet or plank having a thickness greater than that of the complementary element.

### BRIEF DESCRIPTION OF THE DRAWINGS

An embodiment of the invention is now described by way of example with reference to the accompanying drawings in which:

FIG. 1 shows a three dimensional, exploded view of an embodiment of an accessory attaching system;

FIG. 2 shows a three dimensional view of an article of furniture comprising the accessory attaching system; and

FIG. 3 shows a three dimensional view, from below, of an accessory for use with the article of furniture.

### DETAILED DESCRIPTION OF THE EXEMPLARY EMBODIMENT

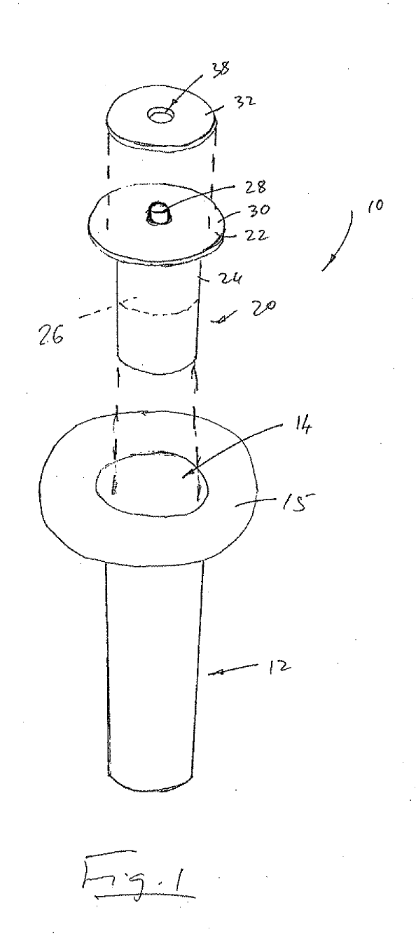

In FIG. 1 of the drawings, reference numeral 10 generally designates an embodiment of an accessory attaching system. The accessory attaching system 10 is intended particularly for use with an article of furniture 13. As indicated, the article of furniture 13 comprises at least two such accessory attaching systems 10.

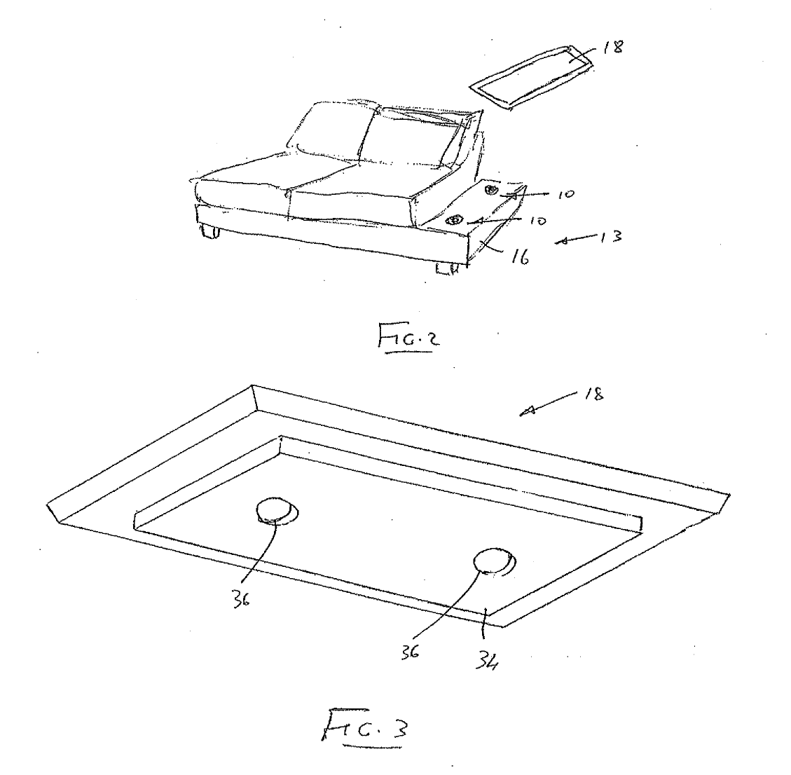

The accessory attaching system 10 comprises a socket defining member in the form of a sleeve 12. The sleeve 12 defines a tapered socket 14. Generally, the sleeve 12 is mounted in a base portion 16 (FIG. 2) of the article of furniture 13. The attaching systems 10 support an accessory 18 in a stable configuration on the base member 16 of the article of furniture 13. The stability of the system 10 is also improved by a collar or flange 15 arranged about an entrance opening of the socket 14 of the sleeve 12.

A retention device comprising a holder 20 is receivable in the socket 14 of the sleeve 12. The holder 20 comprises a crown portion 22 with a skirt portion 24 depending from one side of the crown portion 22. The skirt portion 24 is of smaller diameter than the crown portion 22 and has a taper which is complementary to the taper of the socket 14 of the sleeve 12. Typically, the tapers of the socket 14 and the skirt portion 24 are gradual tapers being less than about 5° and, preferably, about 2° or less. The flange 15 also assists in inserting the holder 20 into the socket 14 of the sleeve 12.

The retention device 20 is a magnetic retention device and comprises a magnet 26 received therein and surrounded by the skirt portion 24. The magnet 26 is a high strength magnet such as a rare earth magnet,

An upper surface of the crown portion 22, opposite the surface from which the skirt portion 24 extends, defines a land from which a restraining formation, in the form of a substantially cylindrical protuberance 28, projects. The protuberance 28 serves to assist in restraining lateral movement of the accessory 18 relative to the base portion 16 of the article of furniture 13, as will be described in greater detail below.

The protuberance 28 engages a complementary element in the form of a washer 32 carried on an underside of the accessory 18. It will be. appreciated that the washer 32 is a ferro-magnetic washer and is attracted by the magnet 26 of the holder 20 to retain the holder 20 in position relative to the accessory 18.

Referring to FIG. 3 of the drawings, an underside of the accessory 18 is shown in greater detail. The accessory 18 carries a member 34 on its underside. The member 34 is, for example, a timber member and defines a plurality of receiving formations in the form of recesses 36. There are the same number of recesses 36 as there are attaching systems 10 applicable to the accessory 18. Each recess 36 accommodates a washer 32 (not shown in FIG. 3) within the recess. Typically, the timber member 34 has a thickness of about 9 or 10 mm and the thickness of the washer 32 is about 4 mm. Thus, when a washer 32 is inserted into its associated recess 36, it is arranged within the recess 36 in a countersunk fashion so that the crown portion 22 of the holder 20 can be received in the recess 36.

Thus, in use, a washer 32 is adhesively bonded in position within its associated recess 36 using a suitably high strength adhesive such as a two-part epoxy adhesive. Once the adhesive has set, the holder 20 is magnetically attached to its associated washer 32 so that the skirt portion 24 projects outwardly from the timber member 34, The protuberance 28 of the holder 20 engages a central opening 38 in the washer 32 in a snug manner to restrain the accessory 18 laterally with respect to the holder 20 and, as a result, with respect to the base member 16 of the article of furniture 10.

Once the holders 20 have been attached to the accessory 18, the accessory 18 is secured to the article of furniture 13 by inserting the skirt portion 24 of each holder into the socket 14 of the associated sleeve 12 within the base member 16 of the article of furniture 13.

In the illustrated embodiment, the accessory 18 is shown as a tray or shelf. It will, however, be appreciated that any suitable accessory can be releasably attached to the base member 16 by means of the accessory attaching system 10. Thus, for example, the accessory 18 could be a cushion, an armrest, a bookcase, a backrest, a headrest or any other accessory, as desired by a user of the article of furniture and which can, appropriately, be attached to the base member 16 of the article of furniture 13.

It is also to be noted that the holder 20, being a snug fit within the socket 14 of its associated sleeve 12 securely holds the accessory 18 in position relative to the base member 16 of the article of furniture 13 and inhibits accidental withdrawal of the accessory 18. The provision of the restraining device 28 also serves securely to locate the accessory 18 laterally with respect to the base member 16 of the article of furniture 13. This can be beneficial in situations where the accessory 18 is, for example, a tray and on which beverages are to be supported.

It is an advantage of an embodiment of the invention that an accessory attaching system 10 is provided which readily assists in supporting the accessory 18 relative to an article of furniture 13 in a stable manner, particularly, in the lateral direction. By having the holder 20 be a close fit within the socket 14 of the sleeve 12, improved stability of the system 10 also results which enhances the feel of quality of the article of furniture 13.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. An accessory attaching system comprising:
a socket defining member to be received by one of an accessory and an underlying component to which the accessory is to be attached;
a retention device mountable to the other of the accessory and the underlying component to retain the accessory and the underlying component in position relative to each other, the retention device being shaped to be a snug fit in a socket defined by the socket defining member; and
a restraining formation carried on the retention device for engaging a complementary element carried by one of the accessory and the underlying component to inhibit lateral displacement of the accessory relative to the underlying component.

2. The system of claim 1, wherein the socket defining member is receivable in the underlying component and the retention device is carried by the accessory.

3. The system of claim 1, wherein the socket defining member comprises a sleeve defining the socket.

4. The system of claim 1, further comprising an outwardly extending flange arranged about an inlet opening of the socket.

5. The system of claim 1, wherein the retention device is a magnetic retention device and comprises a magnet for retention to a ferro-magnetic component in the other of the accessory and the underlying component.

6. The system of claim 5, wherein the retention device comprises a holder that is engageable with the socket and the magnet is received in the holder.

7. The system of claim 1, wherein the socket is tapered.

8. The system of claim 7, wherein the retention device is tapered and the taper of the retention device is complementary to that of the socket so that, in use, the retention device is a snug fit within the socket and locks in position within the socket defining member while inhibiting binding between the socket defining member and the retention device.

9. The system of claim 8, wherein the taper of both the retention device and the socket is less than about 5°.

10. The system of claim 1, wherein the retention device comprises a crown portion with a skirt portion depending from one side of the crown portion.

11. The system of claim 10, wherein the skirt portion is arranged inwardly of a periphery of the crown portion.

12. The system of claim 10, wherein an opposed side of the crown portion defines a land and the restraining formation projects from the land.

13. The system of claim 1, comprising the complementary element, wherein the socket defining member is arranged in the underlying component, and the complementary element is carried on an operatively underside of the accessory.

14. An article of furniture comprising:
a base member forming an underlying component;
at least one accessory releasably attachable to the base member; and
at least one accessory attachment system, comprising:
a socket defining member to be received by one of the accessory and the underlying component;
a retention device mountable to the other of the accessory and the underlying component to retain the accessory and the underlying component in position relative to each other, the retention device being shaped to be a snug fit in a socket defined by the socket defining member; and
a restraining formation carried on the retention device for engaging a complementary element carried by one of the accessory and the underlying component to inhibit lateral displacement of the accessory relative to the underlying component.

15. The article of furniture of claim 14, wherein the accessory defines a receiving formation in which the complementary element of the attachment system is received.

16. The article of furniture of claim 15, wherein the accessory is attached to the underlying component by a plurality of the accessory attachment systems and wherein the accessory defines a receiving formation for each complementary element.

17. The article of furniture of claim 15, wherein each receiving formation defines a recess having a depth greater than a thickness of the complementary element.
